(19) United States
(12) Patent Application Publication
(10) Pub. No.: US 2004/0055776 A1
(43) Pub. Date: Mar. 25, 2004

(54) Stretchable conducting lead

(76) Inventor: Zoran Milijasevic, New South Wales (AU)

Correspondence Address: FINNEGAN, HENDERSON, FARABOW, GARRETT & DUNNER, LLP, 1300 I STREET, NW, WASHINGTON, DC, 20005, US

(21) Appl. No.: 10/312,406

(22) PCT Filed: Jun. 26, 2001
(86) PCT No.: PCT/AU01/00753

(30) Foreign Application Priority Data
Jun. 27, 2000 (AU) PQ 8402

(51) Int. Cl. H01B 7/18

(52) U.S. Cl. 174/108

(57) ABSTRACT

An electrically conducting lead (10) suitable for human implantation. The lead comprises a spiral coil of relatively electrically conducting material, such as one more metal wire strands (11) embedded for at least a portion of its length within an elongate member of relatively electrically insulating material (12). The lead (10) is elongatable to a length that is at least 20% longer than its relaxed length. The lead (10) also remains electrically conducting when elongated to an elongation length longer than said relaxed length.

### TECHNICAL FIELD

The present invention relates to an electrically conducting lead suitable for implantation within an implantee's body.

### BACKGROUND OF THE INVENTION

There are a number of applications that require the use of electrically conducting leads in various locations within an implantee's body. For example, pacemakers, defibrillators, and cochlear implants all rely at least to some extent on the use of implantable electrically conducting leads. Such leads are typically relatively short and generally only have a quite limited capacity to stretch or elongate before the occurrence of permanent deformation. This limited capacity reduces the fatigue life of the lead.

One typical example of an implantable lead used in the prior art is described in International Patent Application WO 83/04182. This application describes a hollow tube to be used in pacemaker applications. In such applications, the leads utilised are required to have an internal bore to enable a stylet to be passed therethrough to assist in placement. The leads are also made of a type of plastic that give rigidity to the lead, as in pacemaker applications strength of the lead is an important characteristic.

The leads of the abovementioned application and of the prior art in general have only required a quite limited degree of fatigue resistance suitable for their application. In the case of pacemakers, the amount of flexing required of the lead is relatively minor, with the lead needing to only cater for chest cavity movements during respiration as well as body size increases experienced during growth of an individual. In general, such elongation is relatively minor and the leads in general are built with strength of the catheter in mind with little or no elongation capability.

Laboratory tests on the tensile elastic limits of a number of conventional pacemaker leads have shown that when such leads where elongated by a relatively small degree from their original lengths, permanent deformation of the lead was experienced. These results may be acceptable for pacemaker/catheter applications, but in other applications where greater elongation is necessary, such results are unacceptable.

Functional electrical stimulation (FES) systems have been developed using electronic body worn equipment which generates and delivers electrical impulses to control muscle movement. In such systems, the electrical impulses are transmitted from implanted stimulator units via electrically conducting leads to strategically positioned electrodes that deliver the electrical impulses directly to the nerves. The electrodes are positioned remote from the implanted stimulator unit proximal to the nerves that direct movement to the associated limbs. With a single implanted stimulator being used to control stimulation to all of the limbs, the amount and length of the leads required can be considerable.

With conventional leads, the length of any implanted lead is usually significantly greater than that required to simply provide electrical connection between a particular stimulator unit and electrode. The greater length is required to ensure that the lead can accommodate a typical full range of body movements of the implantee. In the case of implantees that are still growing, such as children and adolescents, a greater length of lead is also used to ensure the lead can accommodate at least the expected growth of the implantee together with the full range of body movements that may be made by such an implantee. This is also particularly important when the leads need to traverse an individual's torso and limbs, as the amount and variations of movement is quite substantial and the length of the leads must be such that it can accommodate such movement without causing the lead to permanently deform and fail.

To ensure an adequate length of lead is implanted, the lead is often implanted in a coiled fashion. The lead can then uncoil as required on movement or growth of the implantee. The necessity to implant the additional length of medical lead complicates the implantation surgery and increases the overall electrical impedance of the FES system. The need to coil the implanted lead can also involve complications with tissue growth around the coiled leads resulting in the loss of the ability of the coil to accommodate an increase in length as well as the potential for such an action to cause internal damage to the implantee. This has to date proved a significant barrier to the adoption of implantable FES systems.

Therefore, due to the different requirements of the lead in FES applications as opposed to pacemaker/catheter applications, particularly with regard to the amount of elongation required, conventional leads have serious shortcoming, and to date a suitable lead has not existed that caters for an FES application.

The present invention therefore aims to provide an implantable lead that can overcome the shortcomings of conventional leads, whereby the lead can undergo a substantial amount of elongation without experiencing adverse effects resulting in the need for a reduced length of implanted lead being required for such applications. The aim of the present invention is to provide a lead which primarily provides conductivity and flexibility as opposed to rigidity.

Any discussion of documents, acts, materials, devices, articles or the like which has been included in the present specification is solely for the purpose of providing a context for the present invention. It is not to be taken as an admission that any or all of these matters were common general knowledge in the field relevant to the present invention as it existed before the priority date of each claim of this application.

### SUMMARY OF THE INVENTION

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

According to a first aspect, the present invention comprises an elongatable electrically conducting lead, the lead comprising a length of relatively electrically conducting material embedded for at least a portion of its length within an elongate member of relatively electrically insulating material, the lead when not elongated having a relaxed length, wherein the lead is elongatable to a length that is at least 20% longer than the relaxed length and further wherein the lead remains electrically conducting when elongated to an elongation length longer than said relaxed length.

In a preferred embodiment of the first aspect, the relatively electrically conducting material comprises a coil of such material embedded within the elongate member.

According to a further aspect, the present invention is a lead for providing electrical connection between components of an implantable FES system, the lead comprising a coil of relatively electrically conducting material embedded for at least a portion of its length within an elongate member of relatively electrically insulating material.

In yet a further aspect, the present invention is an implantable FES system comprising at least one implanted stimulator unit that outputs electrical impulses via an electrically conducting lead to one or more electrodes that deliver the electrical impulses directly to the nerves of an implantee, the lead comprising a coil of relatively electrically conducting material embedded for at least a portion of its length within an elongate member of relatively electrically insulating material.

In a preferred embodiment of the further aspects, the lead is preferably stretchable or elongatable to a length that is at least 20% longer than its relaxed length and further wherein the lead remains electrically conducting when stretched or elongated to said length longer than the relaxed length. The lead preferably remains resilient when elongated to the length longer than its relaxed length.

The lead in the first aspect can be used to conduct electricity through an implantee's body. In each of the aspects, the lead can be implanted subcutaneously across bone joints within an implantee's body, for example, across the shoulder or hip joint or even a combination of such joints. The lead of the first aspect can preferably be electrically connected to electrodes suitable for implantation in tissue. For example, the leads can extend to electrodes used in functional electrical stimulation (FES) systems to stimulate nerves or muscles within a user's body.

In one embodiment, the lead can have two or more coils of electrically conducting material embedded within the relatively electrically insulating material. Each of the coils are preferably electrically insulated from each other and provide separate electrical conduction paths through the lead. Each coil can comprise a separate spiral helix extending the length of the lead.

In a further embodiment, each coil of relatively electrically conducting material is comprised of at least one metal wire. In a preferred embodiment, each coil is comprised of a plurality of metal wire strands. Each coil can be comprised of between 20 and 400 metal strands. More preferably, the conducting material is formed of between 150 and 300 strands. Still more preferably, it is comprised of between 180 and 275 strands.

In one embodiment, the plural to of strands of each coil are preferably twisted about each other.

In another embodiment, each coil comprises a plurality of twisted bundles of metal strands, each bundle comprising a plurality of electrically conducting strands. In one embodiment, between 5 and 10, and preferably 7, wires are twisted together to form a bundle. Between 2 and 5, and preferably 3, such bundles are then preferably twisted together. In a further embodiment, two such coils can extend the length of the lead.

Each wire strand can have a diameter of between 1 and 40 μm, more preferably between 10 and 30 μm, and still more preferably about 25 μm.

The strands can be formed of stainless steel, such as Baird Medical Grade 316L stainless steel. The strands can also be formed of platinum, a platinum-iridium alloy, titanium or other suitable electrically conducting materials, including non-metals. The strands are preferably biocompatible and have a high relative electrical conductivity. Different materials can be employed in the same bundle or different bundles.

In a still further embodiment, each of the wires and/or each of the bundles of a coil can have an outer layer of relatively electrically insulating material. In a further embodiment, the outer layer can comprise polytetrafluoroethylene (PTFE).

The role of the one or more coils in the lead is preferably to provide electrical conductivity through the lead.

The relatively electrically insulating material of the lead is preferably resiliently flexible. The electrically insulating material can be comprised of a polymeric or elastomeric material. The electrically insulating material is preferably biocompatible. One preferred material is a silicone, such as Silicone NuSil Med-4750. The elongate member can be formed of one layer of material. In another embodiment, the elongate member can be formed of two or more layers. Where formed of two or more layers, the layers can be bonded together. Where there are two or more layers, the layers can be formed of the same material or of different materials. In one embodiment, the elongate member is formed of an inner layer of a silicone and an outer layer of a silicone. In another embodiment, the inner layer is formed of a silicone and the outer layer is comprised of a polymeric material that is heat shrunk about the inner silicone layer.

The elongate electrically insulating material is preferably of circular cross-section. In one embodiment, the elongate electrically insulating material is in the form of a tube having an elongate lumen extending therethrough. The lumen is preferably centrally disposed about the longitudinal axis of the tube when the tube is linearly disposed. The lumen is preferably circular in cross-section. Other cross-sectional shapes can also be envisaged. It can also be envisaged that the cross-sectional shape may vary along the length of the elongate member. The lumen can be used as a drug delivery means. For example, the lumen can be used to deliver tissue growth inhibitors. It is also envisaged that the elongate electrically insulating material is of a solid cross-section without the need of a lumen extending there through.

The tube itself can also be circular in cross-section. Other cross-sectional shapes, such as ovals, squares and rectangles can also be envisaged. The cross-sectional shape of the tube may vary along its length. For example, the tube may be circular in cross-section for a portion of its length and then be rectangular for a portion of its length.

The tube preferably has a substantially smooth outer surface that minimises tissue abrasion on implantation of the lead.

In one embodiment, each coil comprises a spiral helix within the elongate relatively electrically insulating material. Each coil is preferably symmetrically disposed around the longitudinal axis of the electrically insulating member. Where the elongate member is a tube, each coil preferably spirals through the elongate member outwardly of the lumen of the tube. In a preferred embodiment, each spiral coil is disposed between a first layer and a second layer of electrically insulating material. In a further embodiment., each spiral coil can have an outer diameter substantially equal to an outer diameter of the first layer of relatively electrically insulating material.

In a preferred embodiment, the pitch of each spiral coil is constant along the length of the lead. In another embodiment, the pitch is constant for a length and then changes at least once to a different pitch. In a still further embodiment, the pitch varies along the length of the lead. In one embodiment, the pitch is in the range of 0.1 to 25 mm, more preferably between 0.5 to 3 mm, still more preferably about 1.4 mm.

The lead can preferably elongate without undergoing permanent deformation to a length that is between about 20 and 150% of its relaxed length. The lead can preferably undergo an elongation of at least 40%, more preferable about 70%, still more preferably at least about 100%, without permanent deformation. The lead can preferably elongate up to a length of 100% that of the relaxed length on being subject to a force of about 5N or less. The lead preferably remains electrically conducting even if deformed such that it undergoes permanent deformation. It still rather, preferably remains conducting up until break of the lead.

In one embodiment, the lead has an outside diameter of between about 1.2 mm to about 1.5 mm. Other suitable outside diameters can be envisaged. Where the lead is comprised of two layers, the diameter or the inner layer is preferably about 0.9 mm. Where present, the lumen can have a diameter of about 0.3 mm.

The relaxed length of a lead according to the present invention will be dependent on the envisaged application of the lead. In one embodiment, the lead can have a minimum relaxed length of about 750 mm.

According to a still further aspect, the present invention is a method of forming an electrically conducting lead, the method comprising the steps of:

(a) forming a first layer of relatively electrically insulating material for a length about a core wire;

(b) wrapping a relatively electrically conducting material about the first layer for at least a portion of said length of the core wire; and

(c) forming a second layer of relatively electrically insulating material about the relatively electrically conducting material over said length.

The method further preferably comprises a further step of:

(d) removing the core wire from the lead so leaving a lumen within the lead.

The core wire can comprise a metal wire. In another embodiment, the core wire can comprise an annealed metal wire. The core wire can comprise 304, 316 or 316L stainless steel, a copper, or a nickel. The metal wire can have a polymeric coating. The polymeric coating can comprise a layer of polytetrafluoroethylene (PTFE).

In another embodiment, the first layer of electrically insulating material is layered on the core wire by extrusion. The second layer of electrically insulating material can also be layered on the lead by extrusion. In another embodiment, the second layer can be heat shrunk onto the lead. In a further embodiment, the first layer of electrically insulating material can be a different material to that of the second layer. In another embodiment, the layers can be formed of the same material.

The step of wrapping the electrically conducting material can comprise a step of spirally wrapping one or more coils of metal wire, one or more coils formed of a plurality of wires twisted together, or one or more coils formed of a plurality of bundles of wires twisted together, along said at least a portion of the length of the first layer. Each coil can be wrapped along said length with a constant pitch.

Each coil is preferably wrapped about the first layer of the lead. Each coil is preferably wrapped around the first layer such that the outer diameter of the coil is substantially equal, or is equal, to the outer diameter of the inner layer.

The core wire can be removed by stretching the core wire which results in a reduction in the cross-sectional diameter of the core wire. The decrease in diameter together with the PTFE coating allows the lead to be slid from the core wire.

Once formed, the lead is completed by the attachment of appropriate terminations at each end. The terminations can comprise plugs, sockets, clips and other electrical connectors as known in the art.

The capacity of the leads of the present invention to elongate or stretch allow shorter lengths of lead to be implanted in an implantee, such as an implantee receiving an FES system. Use of shorter leads has a number of advantages, including simplifying the implantation surgery by reducing or removing the need to coil the leads on implantation. The relatively shorter lead also reduces the impedance of the leads of the FES system. The capacity of the leads to elongate and flex also reduces the likelihood of the leads damaging sensitive tissues within the body.

### BRIEF DESCRIPTION OF THE DRAWINGS

By way of example only, preferred embodiments of the invention are now described with reference to the accompanying drawings, in which:

FIG. 1 is a view of one embodiment of a lead according to the present invention;

FIG. 2 is an end elevational view of the lead of FIG. 1;

FIG. 3 is an end elevational view of another embodiment of a lead according to the present invention;

FIG. 4 is a part cross-sectional view through line A-A of the lead of FIG. 3; and

FIG. 5 is a perspective view of the lead of FIG. 3.

### BEST MODE FOR CARRYING OUT THE INVENTION

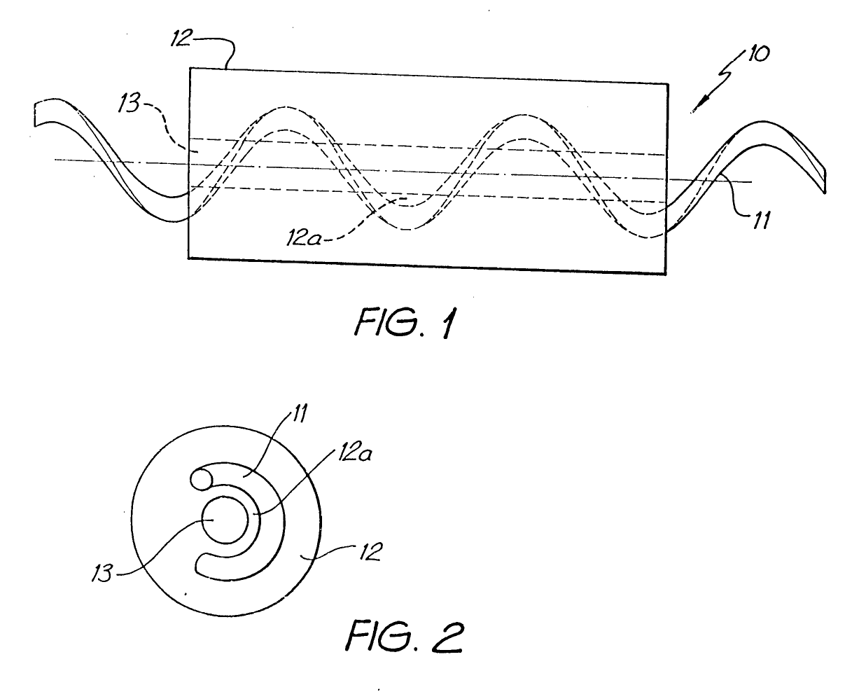

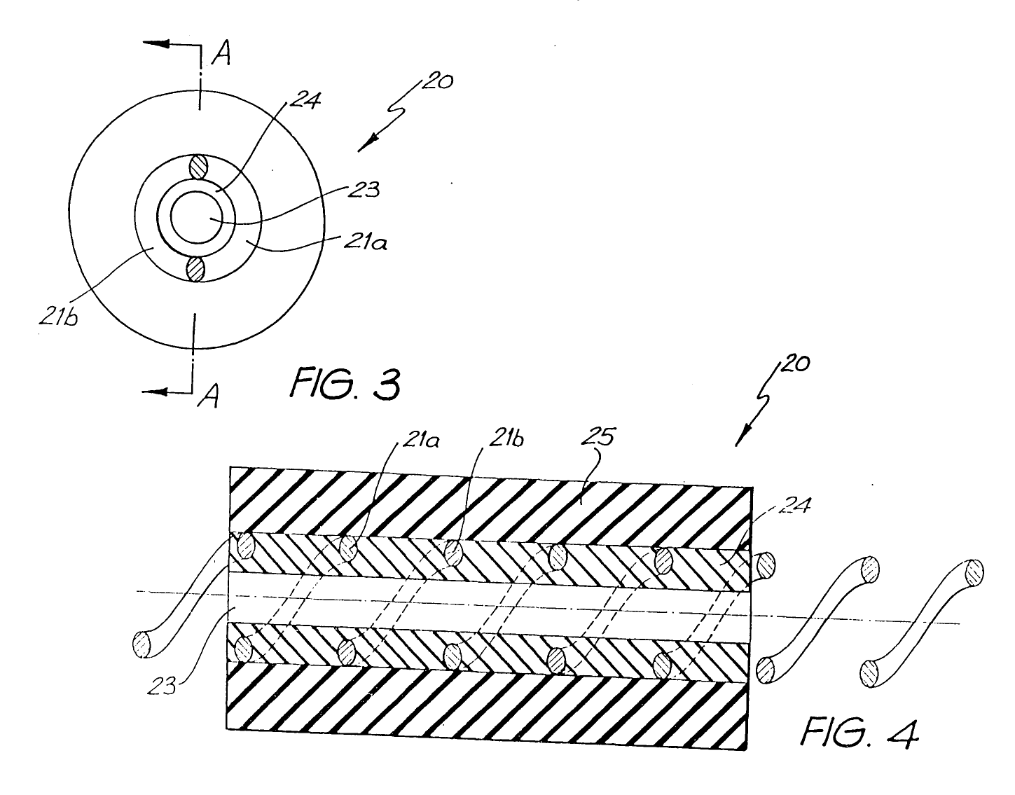

A lead according to one embodiment of the present invention is generally depicted as 10 in FIGS. 1 and 2. The lead 10 is elongatable and implantable within an implantee's body.

The lead 10 comprises one electrically conductive spiral coil 11 embedded within an electrically insulating elongate member 12. In FIGS. 1 and 2, the member 12 is comprised of a single layer of silicone material with the coil 11 embedded therein. As depicted, the lead 10 also has a central lumen 13 extending the length of the member 12. The presence of a lumen is not essential to the present invention.

In FIGS. 1 and 2, the coil 11 is helically wound about the lumen 13 through the length of the member 12. As is depicted in the drawings, the coil 11 is electrically insulated from the lumen 13 by an inner cylindrical portion 12a of the member 12.

The coil 11 is comprised of a plurality of strands of stainless steel wire. In the depicted embodiment, the coil 11 is formed from 180 strands each having a diameter of 14 μm.

The spiral coil 11 serves to allow the depicted lead 10 to elongate or stretch to a length that is at least 100% greater than the normal relayed length of the lead 10, without any permanent deformation of the lead. This capability to elongate is useful where the lead 10 is implanted, such as for use in a FES system. It is particularly useful if the lead 10 is implanted such that it extends across a joint within the implantee's body.

The coil 11 is also sufficiently thin such that the lead 10 does not take up any particular shape but rather is suitable for implantation within an implantee's body. Indeed, in the depicted embodiment, the coil 11, in normal use, plays no significant role in the structural integrity of the lead 10. Only if the lead 10 is stretched to its maximum elongation such that the coil 11 is fully extended does the coil 11 play a role in preventing break of the lead 10.

The depicted lead 10 has an outside diameter of about 1.2 mm and a lumen diameter of about 0.3 mm. The relaxed length of the lead 10 will vary depending on the envisaged application of the lead. In one example, the lead 10 has a minimum relaxed length of about 750 mm.

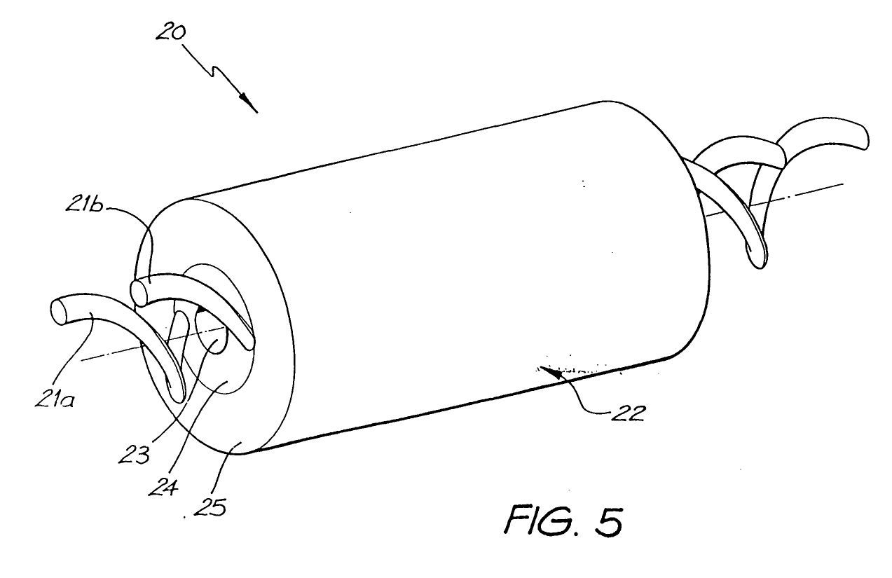

A lead according to a further embodiment of the present invention is generally depicted as 20 in, FIGS. 3 to 5. The lead 20 is also elongatable and implantable within an implantee's body.

In this embodiment, the lead 20 has two spiral coils 21a and 21b wrapped around a central lumen 23.

Each coil 21a and 21b comprises three bundles of wires twisted together, each bundle having 7 strands twisted together to form the bundle.

The coils 21a and 21b are embedded within an elongate member 22. The elongate member 22 is comprised of an inner silicone layer 24 and an outer silicone layer 25. The outer diameter of both of the coils 21a and 21b is equal to the outer diameter of the inner layer 23. While the inner layer 23 and outer layer 24 are both a silicone in the depicted embodiment, it will be appreciated that the respective layers could be formed of different materials.

The spiral coils 21a and 21b again serve to allow the lead 20 to elongate or stretch to a length that is at least 100% greater than the normal relaxed length of the lead 20, without any permanent deformation of the lead. This capability to elongate is useful where the lead 20 is implanted, such as for use in a FES system. It is particularly useful if the lead 20 is implanted such that it extends across a joint within the implantee's body.

Indeed, tests performed by the present inventor have demonstrated that lead 20 has a capacity to elongate by about 100% longer than its relaxed length, without permanent deformation, on application of a force of about 5N. In contrast, similar tests performed on prior art pacemaker leads have suffered permanent deformation when elongated by less than 20%.

The coils 21a and 21b are also sufficiently thin such that the lead 20 does not take up any particular shape but rather is suitable for implantation within a implantee's body. Indeed, in the depicted embodiment, the coils 21a and 21b, in normal use, play no significant role in the structural integrity of the lead 20. Only if the lead 20 is stretched to its maximum elongation such that the coils 21a and 21b are fully extended do they play a role in helping to prevent break of the lead 20.

The depicted lead 20 has dimensions equal to that of lead 10 described above.

For the purposes of the present description, the method of forming the electrically conducting lead 20 will be now described. The method comprises a step of forming, the first layer 23 of relatively electrically insulating material for a length about a core wire (not depicted). The core wire can be a Teflon™ coated copper or stainless steel wire.

The coils 21a and 21b are then formed by spirally winding multifilament wire strand bundles about the first layer 23 over at least a portion of the length of the core wire. A second layer of relatively electrically insulating material 24 is then formed around the coils 21 and 21b over the length.

The method further comprises a step of removing the core wire from the lead 20 so leaving a lumen 23 within the lead 20. By elongating the core wire, its cross-sectional diameter decreases, so allowing it to be removed from the lead 20. The Teflon™ coating also assists in releasing the lead 20 once formed from the core wire. While the lumen 23 need not have a subsequent use, it can be envisaged that the lumen could be utilised as a means of delivering pharmaceutical to the site of an implanted FES electrode in the implantee or other locations.

In another method, the first layer 23 can be formed on the core wire using an extruder. The second layer 24 can also be formed using an extruder. In another method, the second layer 24 can be heat shrunk about the first layer 23 to form the lead 20.

Once formed, the lead 20 is completed by the attachment of appropriate terminations at each end. The terminations can comprise plugs, sockets, clips and other electrical connectors as known in the art.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An elongatable electrically conducting lead, the lead comprising a length of relatively electrically conducting material embedded for at least a portion of its length within an elongate member of relatively electrically insulating material, the lead when not elongated having a relaxed length, wherein the lead is elongatable to a length that is at least 20% longer than the relaxed length and further wherein the lead remains electrically conducting when elongated to said length longer than said relaxed length.

2. An elongatable electrically conducting lead of claim 1 wherein the lead comprises a coil of relatively electrically conducting material.

3. An elongatable electrically conducting lead for providing electrical connection between components of an implantable FES system, the lead comprising a coil of relatively electrically conducting material embedded for at least a portion of its length within an elongate member of relatively electrically insulating material.

4. An elongatable electrically conducting lead of claim 2 or claim 3 wherein the lead has a relaxed length and is elongatable to a length that is at least 20% longer than its relaxed length and further wherein the lead remains electrically conducting when elongated to said length longer than the relaxed length.

5. An elongatable electrically conducting lead of any one of claims 2 to 4 wherein the lead has two or more coils of electrically conducting material embedded within the relatively electrically insulating material.

6. An elongatable electrically conducting lead of claim 5 wherein each of the coils are preferably electrically insulated from each other and provide separate electrical conduction paths through the lead.

7. An elongatable electrically conducting lead of any one of claims 2 to 6 wherein each coil comprise a separate spiral helix extending the length of the lead.

8. An elongatable electrically conducting lead of any one of claims 2 to 7 wherein each coil is comprised of a plurality of metal wire strands.

9. An elongatable electrically conducting lead of any one of claims 2 to 7 wherein each coil comprises a plurality of twisted bundles of metal strands, each bundle comprising a plurality of electrically conducting strands.

10. An elongatable electrically conducting lead of claim 9 wherein each coil comprises three bundles of wires twisted together, each bundle having 7 strands twisted together to form the bundle.

11. An elongatable electrically conducting lead of claim 10 wherein two coils extend the length of the lead.

12. An elongatable electrically conducting lead of claim 10 or 11 wherein each wire strand has a diameter of about 25 μm.

13. An elongatable electrically conducting lead of any one of claims 9 to 12 wherein each coil has an outer layer of relatively electrically insulating material.

14. An elongatable electrically conducting lead of claim 13 wherein the outer layer is polytetrafluoroethylene (PTF).

15. An elongatable electrically conducting lead of any one of claims 2 to 14 wherein the electrically insulating material of the elongate member is comprised of a biocompatable polymeric or elastomeric material.

16. An elongatable electrically conducting lead of claim 15 wherein the biocompatable material is a silicone.

17. An elongatable electrically conducting lead of claim 15 wherein the elongate member is formed of an inner layer and an outer layer.

18. An elongatable electrically conducting lead of any one of the preceding claims wherein the elongate member is in the form of a tube having an elongate lumen extending therethrough, the lumen being centrally disposed about a longitudinal axis of the tube

19. An elongatable electrically conducting lead of claim 18 wherein the tube bas a substantially smooth outer surface that minimises tissue abrasion on implantation of the lead.

20. An elongatable electrically conducting lead of claim 17 wherein each coil is disposed between the inner layer and the outer layer of the elongate member.

21. An elongatable electrically conducting lead of claim 20 wherein each coil has an outer diameter substantially equal to an outer diameter of the first layer of the elongate member.

22. An elongatable electrically conducting lead of any one of the preceding claims wherein the lead can elongate without undergoing permanent deformation to a length that is at least about 100% of its relaxed length.

23. A implantable FES system comprising at least one implanted stimulator unit that outputs electrical impulses via an electrically conducting lead to one or more electrodes that deliver the electrical impulses directly to the nerves of an implantee, the lead comprising a coil of relatively electrically conducting material embedded for at least a portion of its length within an elongate member of relatively electrically insulating material.

24. A method of forming an electrically conducting lead, the method comprising the steps of:
(a) forming a first layer of relatively electrically insulating material for a length about a core wire;
(b) wrapping a relatively electrically conducting material about the first layer for at least a portion of said length of the core wire; and
(c) forming a second layer of relatively electrically insulating material about the relatively electrically conducting material over said length.

25. The method of claim 24 further comprising a step of:
(d) removing the core wire from the lead so leaving a lumen within the lead.

26. The method of claim 24 or claim 25 wherein the core wire comprises a metal wire having a polymeric coating.

27. The method of claim 26 wherein the core wire comprises a metal wire coated with a layer of polytetrafluoroethylene (PTFE).

28. The method of claim 25 wherein the step of wrapping the electrically conducting material comprise a step of spirally wrapping one or more coils formed of a plurality of wire strands twisted together along said at least a portion of the length of the first layer.

29. The method of claim 28 wherein each coil is wrapped about the first layer of the lead such that the outer diameter of the coil is substantially equal, or is equal, to the outer diameter of the inner layer.
